(19) United States
(12) Patent Application Publication
(10) Pub. No.: US 2026/0251768 A1
(43) Pub. Date: Aug. 27, 2026

(54) CONTROL DEVICE, DISTANCE MEASURING DEVICE, AND CONTROL METHOD

(71) Applicant: Sony Group Corporation, Tokyo (JP)

(72) Inventors: Tomohiro NISHI, Tokyo (JP); Yuta SAKURAI, Chiba (JP); Masatoshi YOKOKAWA, Kanaga (JP)

(73) Assignee: Sony Group Corporation, Tokyo (JP)

(21) Appl. No.: 19/162,270

(22) PCT Filed: Mar. 7, 2024
(86) PCT No.: PCT/JP2024/008691

§ 371 Date: Sep. 4, 2025

(30) Foreign Application Priority Data
Mar. 29, 2023 (JP) 2023-054281

(51) Int. Cl. G01S 7/487; G01S 7/4865; G01S 17/10; G01S 17/89; H04N 25/46; H04N 25/61; H04N 25/626

(52) U.S. Cl. CPC G01S 7/4876; G01S 7/4865; G01S 17/10; G01S 17/89; H04N 25/61; H04N 25/626; H04N 25/46

(57) ABSTRACT

A control unit is a control device that detects an echo with respect to pulsed laser light based on a physical quantity of photons incident on each of a plurality of SPAD pixels arranged. The control unit includes an invalidation section determination unit and a SPAD control unit. In a case where the saturated echo in which the echo is saturated for a predetermined time or more is detected, the invalidation section determination unit determines a SPAD invalidation section so that a start time point of the SPAD invalidation section invalidating the SPAD pixel that has detected the saturated echo is set as a start time point of the saturated echo and the SPAD invalidation section gradually decreases every time the laser light is emitted. The SPAD control unit invalidates the SPAD pixel according to the determined SPAD invalidation section and makes the laser light to be emitted.

### FIELD

The present disclosure relates to a control device, a distance measuring device, and a control method.

### BACKGROUND

In recent years, a distance image sensor (hereinafter, also referred to as a time-of-flight (ToF) sensor) that measures a distance by a ToF method has attracted attention. For example, there is a ToF sensor that is manufactured by using a complementary metal oxide semiconductor (CMOS) semiconductor integrated circuit technology and measures a distance to an object using a plurality of planarly arranged single photon avalanche diodes (SPADS).

In the ToF sensor using the SPAD, the time from when the light source emits light to when the photon of the reflected light (hereinafter, referred to as echo) is incident on the SPAD (hereinafter, the time is referred to as flight time) is measured a plurality of times as a physical quantity. Then, the distance to the object is specified based on the histogram of the physical quantity generated from the measurement result.

### CITATION LIST

### Patent Literature

Patent Literature 1: JP2016-533140 A

### SUMMARY

### Technical Problem

However, in the ToF sensor using the SPAD, when continuous echoes are incident, the first wave can be observed, but there may be a case where the subsequent second wave cannot be observed. This is because the SPAD is saturated by the first wave, and a pseudo response that does not depend on incidence of light may occur for a while. This dead period is called “dead time”. Therefore, the ToF sensor using the SPAD has a problem that an echo incident during the dead time cannot be observed.

Therefore, the present disclosure proposes a control device, a distance measuring device, and a control method that enable observation of an echo that cannot be observed during the dead time.

### Solution to Problem

In order to solve the above problems, one aspect of a control device according to the present disclosure detects an echo with respect to pulsed emission light based on a physical quantity of photons incident on each of a plurality of pixels arranged. The control device includes: a determination unit that, in a case where a saturated echo in which the echo is saturated for a predetermined time or more is detected, determines an invalidation section such that a start time point of the invalidation section invalidating the pixel that has detected the saturated echo is set as a start time point of the saturated echo and the invalidation section gradually decreases every time the emission light is emitted; and a pixel control unit that invalidates the pixel according to the determined invalidation section and makes the emission light to be emitted.

### BRIEF DESCRIPTION OF DRAWINGS

FIG. 1 is a block diagram illustrating a schematic configuration example of a ToF sensor as a distance measuring device according to an embodiment of the present disclosure.

FIG. 2 is an explanatory diagram of an optical system including the ToF sensor according to the embodiment of the present disclosure.

FIG. 3 is a block diagram illustrating a schematic configuration example of a light receiving unit according to the embodiment of the present disclosure.

FIG. 4 is an explanatory diagram of an example of observation data in the ToF sensor according to the embodiment of the present disclosure.

FIG. 5 is an explanatory diagram of a data structure of the observation data.

FIG. 6 is an explanatory diagram of a dead time.

FIG. 7 is an explanatory diagram of a control method according to the embodiment of the present disclosure.

FIG. 8 is a block diagram illustrating a configuration example of a control unit according to the embodiment of the present disclosure.

FIG. 9 is a flowchart indicating a processing procedure executed by the control unit according to the embodiment of the present disclosure.

FIG. 10 is a block diagram illustrating a configuration example of a control unit according to a modification.

FIG. 11 is an explanatory diagram in a case of being combined with flare removal processing.

FIG. 12 is a hardware configuration diagram illustrating an example of a computer that implements functions of the control unit.

FIG. 13 is a block diagram illustrating an example of a schematic configuration of a vehicle control system.

FIG. 14 is an explanatory view illustrating an example of installation positions of a vehicle exterior information detection unit and an imaging unit.

### DESCRIPTION OF EMBODIMENTS

Hereinafter, an embodiment of the present disclosure will be described in detail with reference to the drawings. Note that, in the following embodiment, the same parts are denoted by the same reference numerals, and redundant description will be omitted.

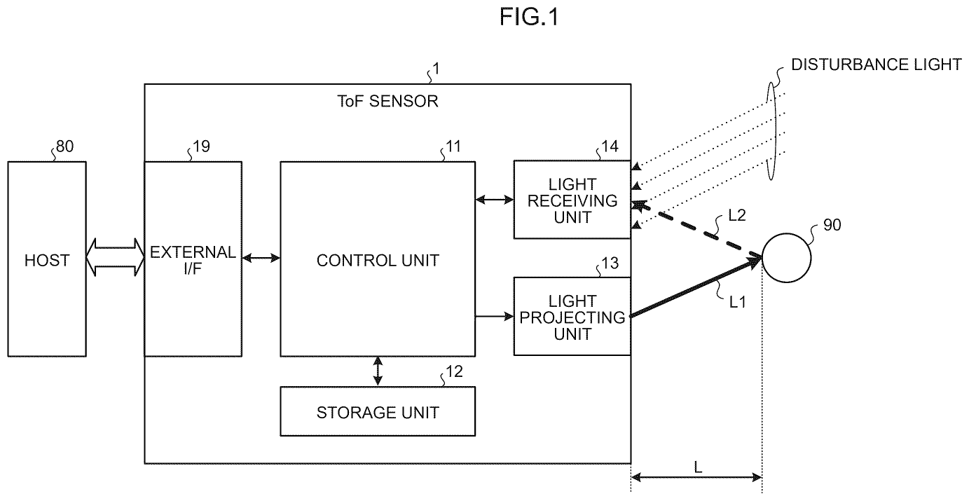

In addition, in the following description, it is assumed that a distance measuring device according to the embodiment of the present disclosure (hereinafter, appropriately referred to as the “present embodiment”) is a ToF sensor 1 illustrated in FIG. 1 and subsequent drawings. Furthermore, it is assumed that a control device according to the present embodiment is a control unit 11 included in the ToF sensor 1. Moreover, in the following description, it is assumed that a control method according to the present embodiment is a control method executed by the control unit 11.

In addition, the present disclosure will be described according to the following item order.
1. Outline
1-1. Distance measuring device (ToF sensor)
1-2. Optical system
1-3. Light receiving unit
1-4. Example of observation data
1-5. Dead time
1-6. Outline of control method according to present embodiment
2. Configuration example of control unit
3. Processing procedure
4. Modifications
4-1. Combination with flare removal processing and effect thereof
4-2. Determination of length of SPAD invalidation section and SPAD validation section
4-3. Ratio between SPAD invalidation section and SPAD validation section
4-4. Others
5. Hardware configuration
6. Application example
7. Conclusion

### 1. Outline

First, an outline of the present embodiment will be described with reference to FIGS. 1 to 7.

### 1-1. Distance Measuring Device (ToF Sensor)

FIG. 1 is a block diagram illustrating a schematic configuration example of the ToF sensor 1 as a distance measuring device according to the present embodiment. As illustrated in FIG. 1, the ToF sensor 1 includes the control unit 11, a storage unit 12, a light projecting unit 13, a light receiving unit 14, and an external interface (I/F) 19.

The control unit 11 controls each unit of the ToF sensor 1. The control unit 11 is implemented by, for example, a central processing unit (CPU), a micro processing unit (MPU), or the like executing a program according to the present embodiment stored in the storage unit 12 using a random access memory (RAM) as a work area. In addition, the control unit 11 can be implemented by, for example, an integrated circuit such as an application specific integrated circuit (ASIC) or a field programmable gate array (FPGA).

The storage unit 12 is implemented by, for example, a storage device such as a RAM, a read only memory (ROM), or a flash memory.

The light projecting unit 13 includes, for example, one or a plurality of semiconductor laser diodes as a light source. Under the control of the control unit 11, the light projecting unit 13 emits pulsed laser light (also referred to as emission light) L1 having a predetermined time width at a predetermined cycle (also referred to as a light emission cycle). Furthermore, the light projecting unit 13 emits the laser light L1 having a time width of 1 ns (nanosecond) at a cycle of 1 MHZ (megahertz), for example. For example, in a case where an object 90 is present within a distance measurement range, the laser light L1 emitted from the light projecting unit 13 is reflected by the object 90 and is incident on the light receiving unit 14 as reflected light L2.

Although details thereof will be described later, the light receiving unit 14 includes, for example, a plurality of SPAD pixels arranged in a two-dimensional lattice pattern. The light receiving unit 14 outputs, to the control unit 11, information regarding the number of SPAD pixels (hereinafter, referred to as a “detected number”) in which incidence of photons has been detected after light emission by the light projecting unit 13 (for example, such a number corresponds to the number of detection signals to be described later). For example, the light receiving unit 14 detects the incidence of photons at a predetermined sampling cycle for one light emission of the light projecting unit 13 and outputs the detected number.

The control unit 11 aggregates the detected number output from the light receiving unit 14 for each of a plurality of SPAD pixels (for example, corresponding to one or a plurality of macro pixels to be described later) and based on pixel values obtained by the aggregation, generates a histogram with the horizontal axis representing flight time and the vertical axis representing a cumulative pixel value. For example, the control unit 11 obtains a pixel value by aggregating the detected number at a predetermined sampling frequency for one light emission of the light projecting unit 13 and repeatedly executes this for a plurality of times of light emission of the light projecting unit 13, thereby generating a histogram in which the horizontal axis (bin of the histogram) represents a sampling cycle corresponding to the flight time and the vertical axis represents a cumulative pixel value obtained by accumulating pixel values obtained in each sampling cycle.

In addition, after performing predetermined filter processing on the generated histogram, the control unit 11 specifies the flight time when the cumulative pixel value reaches the peak from the histogram after the filter processing. Then, based on the specified flight time, the control unit 11 calculates the distance from the ToF sensor 1 or the device equipped with the ToF sensor 1 to the object 90 present within the distance measurement range. Note that the information regarding the distance calculated by the control unit 11 is output to a host 80 or the like via the external I/F 19, for example.

The external I/F 19 is, for example, a communication adapter for establishing communication with the external host 80 via a communication network conforming to an arbitrary standard such as a controller area network (CAN), a local interconnect network (LIN), or FlexRay (registered trademark) in addition to a wireless local area network (LAN) or a wired LAN.

For example, in a case where the ToF sensor 1 is mounted on an automobile or the like, the host 80 is an electronic control unit (ECU) or the like mounted on the automobile or the like. Furthermore, in a case where the ToF sensor 1 is mounted on an autonomous mobile robot such as a domestic pet robot, or on an autonomous mobile body such as a robot cleaner, an unmanned aerial vehicle, or a following conveyance robot, the host 80 is, for example, a control device or the like that controls the autonomous mobile body.

### 1-2. Optical System

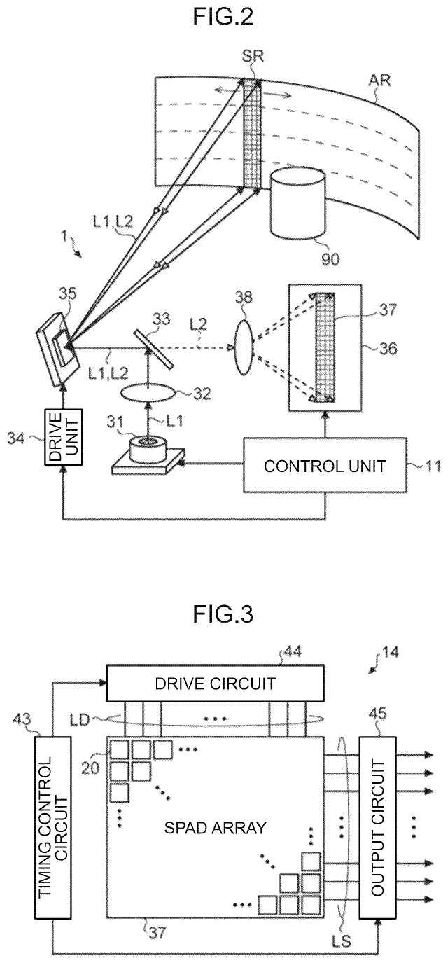

Next, FIG. 2 is an explanatory diagram of an optical system including the ToF sensor 1 according to the present embodiment. Note that, in FIG. 2, a so-called scanning type optical system in which the angle of view of the light receiving unit 14 is scanned in the horizontal direction is exemplified, but the present embodiment is not limited thereto, and for example, a so-called flash type optical system in which the angle of view of the light receiving unit 14 is fixed can be used.

As illustrated in FIG. 2, the ToF sensor 1 includes, as the optical system, a light source 31, a collimator lens 32, a half mirror 33, a galvano mirror 35, a light receiving sensor 36, and a light receiving lens 38. The light source 31, the collimator lens 32, the half mirror 33, and the galvano mirror 35 are included in the light projecting unit 13 in FIG. 1, for example. In addition, the light receiving sensor 36 and the light receiving lens 38 are included in the light receiving unit 14 in FIG. 1, for example.

In the configuration illustrated in FIG. 2, the laser light L1 emitted from the light source 31 is converted into rectangular parallel light in which the intensity spectrum of the cross section is long in the vertical direction by the collimator lens 32, and then is incident on the half mirror 33. The half mirror 33 reflects a part of the incident laser light L1. The laser light L1 reflected by the half mirror 33 is incident on the galvano mirror 35. For example, the galvano mirror 35 vibrates in the horizontal direction about a predetermined rotation axis by a drive unit 34 that operates based on the control from the control unit 11. As a result, the laser light L1 is horizontally scanned such that an angle of view SR of the laser light L1 reflected by the galvano mirror 35 reciprocates in a distance measurement range AR in the horizontal direction. Note that a micro electro mechanical system (MEMS), a micromotor, or the like can be used as the drive unit 34.

The laser light L1 reflected by the galvano mirror 35 is reflected by the object 90 present in the distance measurement range AR and is incident on the galvano mirror 35 as the reflected light L2. A part of the reflected light L2 incident on the galvano mirror 35 is transmitted through the half mirror 33 and is incident on the light receiving lens 38, thereby forming an image on a SPAD array 37 in the light receiving sensor 36. Note that the SPAD array 37 may be the entire light receiving sensor 36 or a part thereof.

### 1-3. Light Receiving Unit

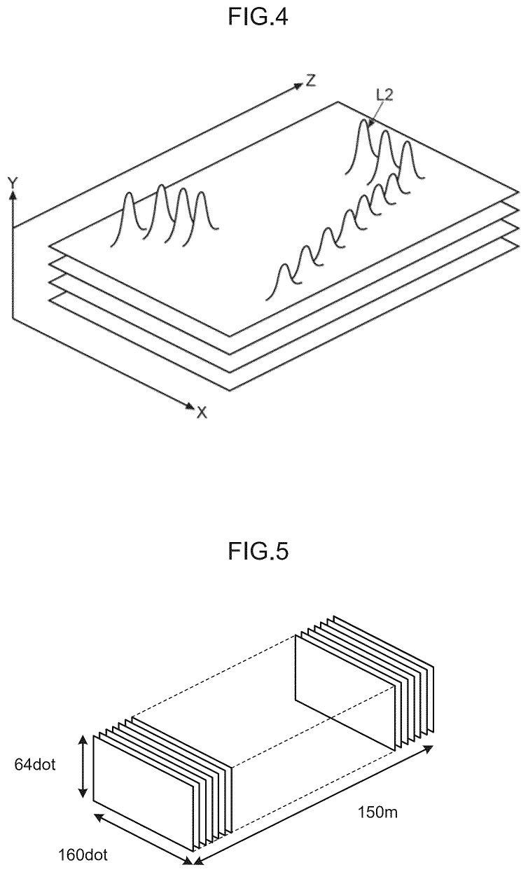

Next, FIG. 3 is a block diagram illustrating a schematic configuration example of the light receiving unit 14 according to the present embodiment. As illustrated in FIG. 3, the light receiving unit 14 includes the SPAD array 37, a timing control circuit 43, a drive circuit 44, and an output circuit 45.

The SPAD array 37 includes a plurality of SPAD pixels 20 arranged in a two-dimensional lattice pattern. In the plurality of SPAD pixels 20, a pixel drive line LD (vertical direction in the drawing) is connected for each column, and an output signal line LS (horizontal direction in the drawing) is connected for each row. One end of the pixel drive line LD is connected to an output end corresponding to each column of the drive circuit 44, and one end of the output signal line LS is connected to an input end corresponding to each row of the output circuit 45.

In the present embodiment, the reflected light L2 is detected using all or a part of the SPAD array 37. The region used in the SPAD array 37 may be a rectangle long in the vertical direction which is the same as the image of the reflected light L2 formed on the light receiving sensor 36 when the entire laser light L1 is reflected as the reflected light L2. However, the region is not limited thereto, and various modifications such as a region larger or a region smaller than the image of the reflected light L2 formed on the SPAD array 37 may be used.

The timing control circuit 43 includes a timing generator or the like that generates various timing signals, and controls the drive circuit 44 and the output circuit 45 based on the various timing signals generated by the timing generator.

The drive circuit 44 includes a shift register, an address decoder, and the like, and drives each of the SPAD pixels 20 of the SPAD array 37 in, for example, a macro-pixel unit or column unit including one or a plurality of SPAD pixels 20, or all pixels at the same time. In the present embodiment, the drive circuit 44 selects each of the SPAD pixels 20 to be driven based on the control of the control unit 11.

Note that, in the following description, the control unit 11 causing the drive circuit 44 to select each of the SPAD pixels 20 to be driven may be expressed as the control unit 11 “validates” the SPAD pixel 20. On the other hand, the control unit 11 causing the drive circuit 44 to select each of the SPAD pixels 20 that is not driven may be expressed as the control unit 11 “invalidates” the SPAD pixel 20.

The control unit 11 validates an arbitrary SPAD pixel 20 by controlling an enable signal of the SPAD pixel 20, to the drive circuit 44, to turn on. In addition, the control unit 11 invalidates an arbitrary SPAD pixel 20 by controlling the enable signal of the SPAD pixel 20, to the drive circuit 44, to turn off.

The detection signal output from each SPAD pixel 20 of the column selectively scanned by the drive circuit 44 is input to the output circuit 45 through each of the output signal lines LS. The output circuit 45 outputs the detection signal input from each SPAD pixel 20 to the control unit 11.

### 1-4. Example of Observation Data

Next, FIG. 4 is an explanatory diagram of an example of observation data in the ToF sensor 1 according to the embodiment of the present disclosure. In addition, FIG. 5 is an explanatory diagram of a data structure of the observation data.

As illustrated in FIG. 4, the detection signal input from the light receiving unit 14 to the control unit 11 is observed as a laser waveform in an orthogonal coordinate system in which an X axis is the horizontal direction, a Y-axis direction is the vertical direction, and a Z-axis direction is the time direction (also referred to as the “depth direction”). Based on this observation data, the control unit 11 sets, as ToF, a peak position of the luminance (detected number of photons) of the reflected light L2 which is the laser light L1 emitted from the light projecting unit 13 and reflected by the object 90 present within the angle of view of each SPAD pixel 20, and performs distance conversion.

As illustrated in FIG. 5, the control unit 11 handles the data structure of the observation data as a time-by-time aggregate of luminance images (corresponding to mapping information on the XY plane in FIG. 4) by the SPAD array 37. Note that values of the number of dots and the distance (m) indicated in FIG. 5 are merely examples.

### 1-5. Dead Time

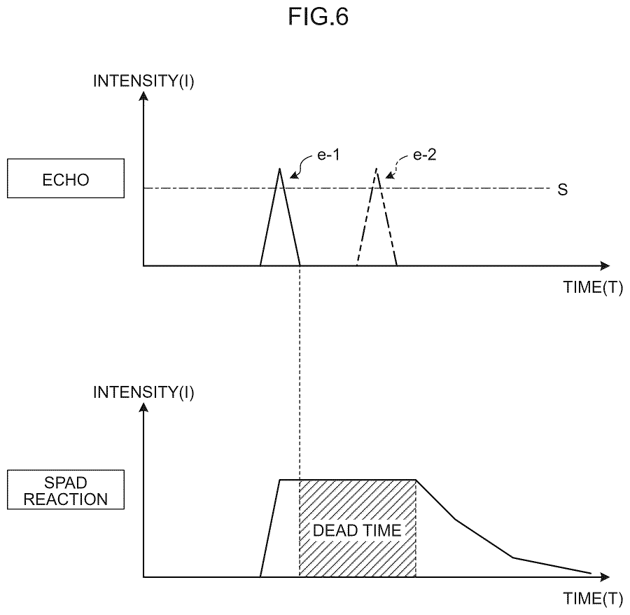

By the way, in the ToF sensor according to the existing technology, when continuous echoes are incident, the first wave can be observed, but there may be a case where the subsequent second wave cannot be observed. FIG. 6 is an explanatory diagram of the dead time.

As illustrated in FIG. 6, in the ToF sensor according to the existing technology, in a case where an echo e-1, which is the first wave having a strong intensity exceeding a saturation exposure amount S of the SPAD pixel 20, is incident on the SPAD, the SPAD pixel 20 is saturated, and the dead time, which is a pseudo response that does not depend on incidence of light, may occur. The dead time increases as the intensity of the echo e-1 increases.

Therefore, the existing technology has a problem that an echo e-2, which is the second wave, incident during the dead time cannot be observed. That is, the ToF sensor according to the existing technology cannot determine whether there is the echo e-2 that is latently incident during the dead time or whether only the echo e-1 having a strong intensity is incident in the first place. Note that, in the following description, the echo that is latently incident during the dead time will be appropriately referred to as a “latent echo”.

### 1-6. Outline of Control Method According to Present Embodiment

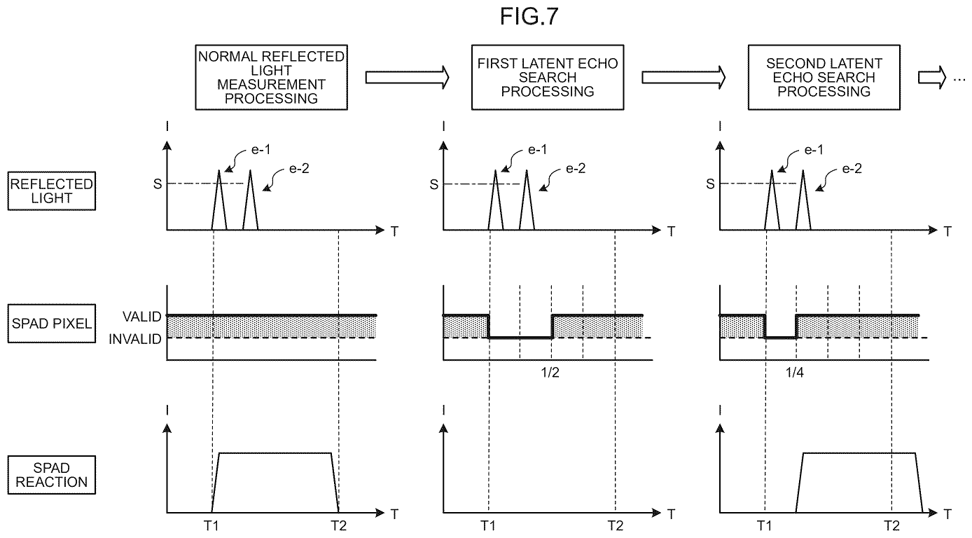

Thus, in the control method according to the present embodiment, the control unit 11 detects an echo with respect to the laser light L1 based on the physical quantity of photons incident on each of the plurality of SPAD pixels 20 arranged. In addition, in a case where a saturated echo in which the echo is saturated for a predetermined time or more is detected, the control unit 11 determines the SPAD invalidation section invalidating the SPAD pixel 20 that has detected the saturated echo to gradually decrease using an end time point of the saturated echo as a reference. More specifically, a start time point of the SPAD invalidation section is set as a start time point of the saturated echo, and the SPAD invalidation section is gradually decreased every time the laser light L1 is emitted. In addition, the control unit 11 invalidates the SPAD pixel 20 according to the determined SPAD invalidation section and makes the laser light L1 to be emitted. FIG. 7 is an explanatory diagram of the control method according to the embodiment of the present disclosure.

Specifically, as illustrated in FIG. 7, in the control method according to the present embodiment, the control unit 11 of the ToF sensor 1 first causes the light projecting unit 13 to perform the first emission of the laser light L1 and executes normal reflected light measurement processing based on the reflected light L2. At this time, the control unit 11 controls the enable signals for all the SPAD pixels 20 to turn on and validates all the SPAD pixels 20.

It is assumed that an echo e-1 exceeding the saturation exposure amount S is incident with respect to the first emission of the laser light L1, and the light receiving unit 14 outputs a detection signal indicated as a laser waveform including the dead time to the control unit 11 as indicated in “SPAD reaction” in the drawing. As a result, the control unit 11 detects the echo e-1 saturated for a predetermined time or more by the normal reflected light measurement processing.

When detecting the echo e-1 saturated for a predetermined time or more, the control unit 11 executes latent echo search processing of searching for the presence or absence of a latent echo at time points T1 and T2 at which the echo e-1 is observed.

In the latent echo search processing, the control unit 11 determines the SPAD invalidation section with the time point T1 as a start time point at the time points T1 and T2 at which the echo e-1 is observed. At this time, the control unit 11 determines the SPAD invalidation section by changing the SPAD validation section so that the SPAD invalidation section gradually decreases from the time point T2 side for every one emission of the laser light L1 in the latent echo search processing.

Then, the control unit 11 detects the latent echo in the SPAD validation section changed in this way. Note that, in the latent echo search processing, the control unit 11 dynamically controls the validation or invalidation of the SPAD, for example, in a unit of each SPAD pixel that has detected the echo e-1 or in a macro-pixel unit including the corresponding SPAD pixel 20.

In the latent echo search processing, as illustrated in FIG. 7, for example, the control unit 11 invalidates the SPAD from the time point T1 to a ½ time point between the time points T1 and T2, and validates the SPAD from the ½ time point to the time point T2, in the first latent echo search processing. After that, the control unit 11 causes the light projecting unit 13 to emit the laser light L1 once, and executes reflected light measurement processing for the reflected light L2.

As a result, when no latent echo is detected, the control unit 11 invalidates the SPAD from the time point T1 to a ¼ time point between the time points T1 and T2 and validates the SPAD from the ¼ time point to the time point T2, in the second latent echo search processing.

After that, the control unit 11 causes the light projecting unit 13 to emit the laser light L1 once, and executes reflected light measurement processing for the reflected light L2.

Then, as illustrated in FIG. 7, when the rise of an echo e-2 can be detected as a latent echo in the second latent echo search processing, the control unit 11 records the echo e-2 separately from the echo e-1. In addition, when the latent echo cannot be detected in the second latent echo search processing, the control unit 11 repeats the latent echo search processing in the procedure similar to the first latent echo search processing and second latent echo search processing. Note that, when a predetermined end condition is satisfied, the control unit 11 ends the repetition of the latent echo search processing. The predetermined end condition includes a case where the number of executions of the latent echo search processing exceeds a specified value (first specified value), a case where the length of the invalidation section of the SPAD becomes equal to or less than a specified value (second specified value), or the like.

As described above, in the control method according to the present embodiment, the control unit 11 detects the echo with respect to the laser light L1 based on the physical quantity of photons incident on each of the plurality of SPAD pixels 20 arranged. In addition, in a case where the saturated echo in which the echo is saturated for a predetermined time or more is detected, the control unit 11 determines the SPAD invalidation section so that the start time point of the SPAD invalidation section invalidating the SPAD pixel 20 that has detected the saturated echo is set as the start time point of the saturated echo and the SPAD invalidation section gradually decreases every time the laser light L1 is emitted. Furthermore, the control unit 11 invalidates the SPAD pixel 20 according to the determined SPAD invalidation section and makes the laser light L1 to be emitted.

Therefore, according to the control method of the present embodiment, it becomes possible to observe an echo that cannot be observed during the dead time.

In addition, in the control method of the present embodiment, targeting only the saturated echo, the control unit 11 controls the validation/invalidation of the SPAD pixel 20 that has detected this saturated echo. Therefore, according to the control method of the present embodiment, there is no influence on the sensitivity to an echo with a weak intensity that is not saturated. As a result, it is possible to suppress a decrease in the distance measurement accuracy of the ToF sensor 1.

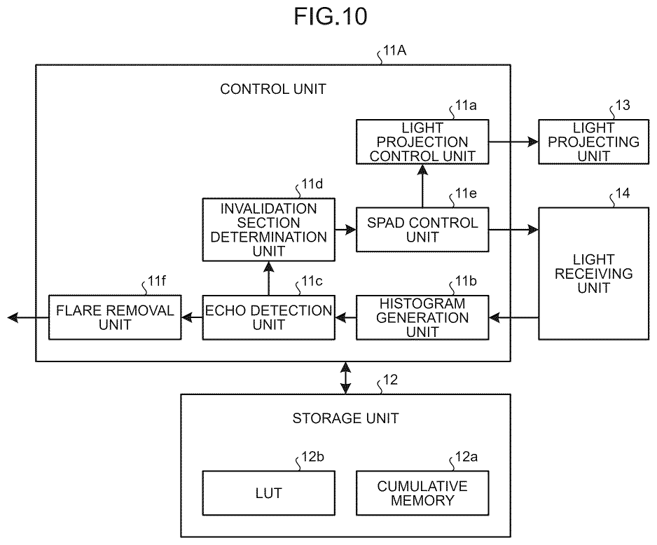

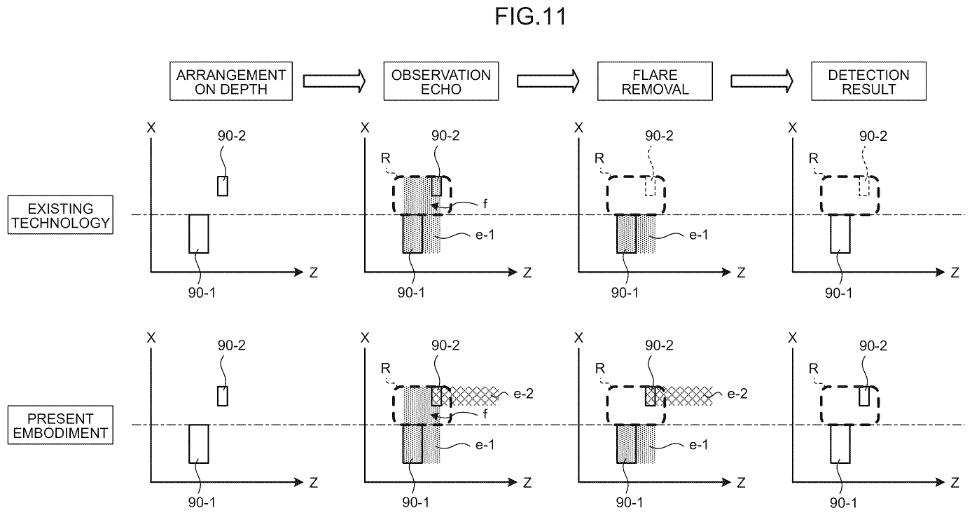

Furthermore, the control unit 11 may further execute flare removal processing of removing flare in which scattered light of highly reflected light saturates the surrounding SPAD pixels 20 and is detected as a false echo. In this case, the control method of the present embodiment can also prevent true echoes that could not be observed due to flare from being removed by the flare removal processing. This modification will be described later with reference to FIGS. 10 and 11. In the following description, a configuration example of the control unit 11 according to the present embodiment will be described more specifically.

### 2. Configuration Example of Control Unit

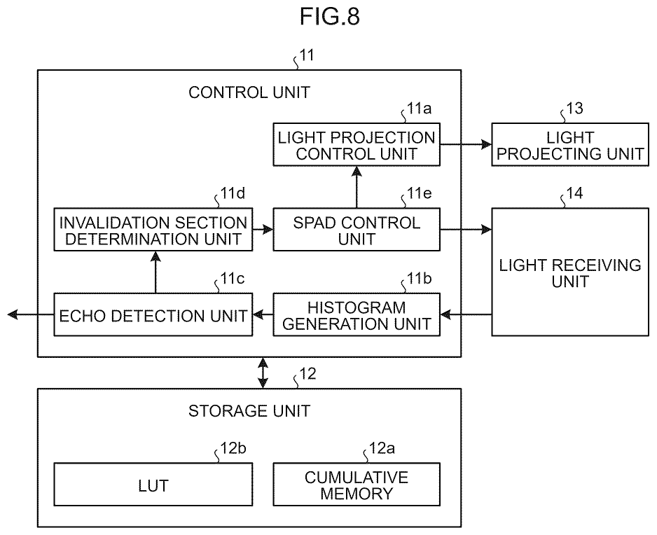

FIG. 8 is a block diagram illustrating the configuration example of the control unit 11 according to the embodiment of the present disclosure. Note that, in FIG. 8 and FIG. 10 described later, only components necessary for describing features of the embodiment of the present disclosure are illustrated, and descriptions of general components are omitted.

In other words, each of the components illustrated in FIGS. 8 and 10 is functionally conceptual, and is not necessarily physically configured as illustrated in the drawings. For example, a specific form of distribution and integration of each block is not limited to the illustrated form, and all or a part thereof can be functionally or physically distributed and integrated in an arbitrary unit according to various loads, usage conditions, and the like.

In the description using FIGS. 8 and 10, the description of the already described components may be simplified or omitted.

As illustrated in FIG. 8, the control unit 11 includes a light projection control unit 11a, a histogram generation unit 11b, an echo detection unit 11c, an invalidation section determination unit 11d, and a SPAD control unit 11e, and implements or executes a function and an action of information processing described later.

The storage unit 12 includes a cumulative memory 12a and a lookup table (LUT) 12b. The cumulative memory 12a stores the above-described cumulative pixel value.

The LUT 12b is a lookup table in which a fixed value of the length of the SPAD validation section that retrospectively extends from the observation end time point of the saturated echo is set in advance every time one laser light L1 is emitted in the latent echo search processing. In the LUT 12b, a fixed value of the length of the SPAD invalidation section, which gradually decreases according to the change in the SPAD validation section, from the observation start time point of the echo may be set in advance.

The light projection control unit 11a controls the light projecting unit 13. The light projection control unit 11a causes the light projecting unit 13 to emit the pulsed laser light L1 having a predetermined time width at a predetermined cycle. In addition, the light projection control unit 11a causes the light projecting unit 13 to emit one laser light L1 each time the SPAD invalidation section is changed by the SPAD control unit 11e described later in the latent echo search processing.

The histogram generation unit 11b aggregates the detected number output from the light receiving unit 14 for each SPAD pixel 20 (for example, one or a plurality of macro-pixel units), and stores the cumulative pixel value obtained by the aggregation in the cumulative memory 12a. In addition, the histogram generation unit 11b generates the above-described histogram based on the cumulative pixel value stored in the cumulative memory 12a.

The echo detection unit 11c detects an echo based on the histogram generated by the histogram generation unit 11b. Note that, in a case where a saturated echo saturated for a predetermined time or more is present among the detected echoes, the echo detection unit 11c extracts the corresponding saturated echo as a target of the latent echo search processing.

For example, in a case where a prescribed number or more of luminance images including the same peak exceeding the saturation exposure amount S is present in the data structure of the above-described observation data, the echo detection unit 11c determines that an echo corresponding to this peak is the saturated echo saturated for a predetermined time or more.

The invalidation section determination unit 11d determines the SPAD invalidation section from the start time point of each of the saturated echoes extracted by the echo detection unit 11c based on the LUT 12b. In addition, the invalidation section determination unit 11d notifies the SPAD control unit 11e of the determined SPAD invalidation section and the SPAD validation section corresponding thereto.

The SPAD control unit 11e dynamically controls the validation or invalidation of the SPAD based on the content determined by the invalidation section determination unit 11d. The SPAD control unit 11e controls the enable signal for the SPAD pixel 20, which has detected a saturated echo to be a target of the latent echo search processing, to turn on/off according to the content determined by the invalidation section determination unit 11d.

Furthermore, each time the SPAD invalidation section and the SPAD validation section are changed, the SPAD control unit 11e causes the light projection control unit 11a to emit one laser light L1 from the light projecting unit 13.

The echo detection unit 11c detects an echo in consideration of the histogram generated by the histogram generation unit 11b in the latent echo search processing. Note that, in a case where the latent echo search processing is unnecessary, the echo detection unit 11c detects an echo based on the histogram generated by the histogram generation unit 11b in the normal reflected light measurement processing.

The echo detection unit 11c specifies the flight time when the above-described cumulative pixel value reaches the peak based on the detected echo. In addition, based on the specified flight time, the echo detection unit 11c calculates the distance from the ToF sensor 1 or the device equipped with the ToF sensor 1 to the object 90 present within the distance measurement range. Furthermore, the echo detection unit 11c outputs information regarding the calculated distance to the host 80 or the like via the external I/F 19, for example.

### 3. Processing Procedure

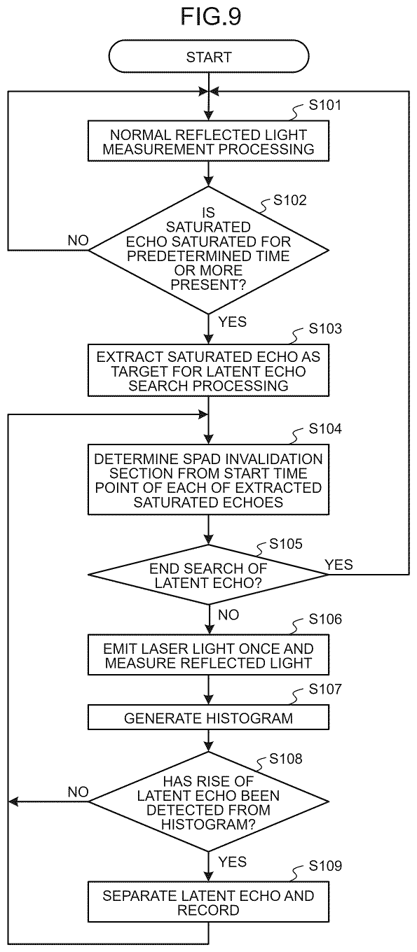

Next, a processing procedure executed by the control unit 11 according to the present embodiment will be described with reference to FIG. 9. FIG. 9 is a flowchart indicating a processing procedure executed by the control unit 11 according to the embodiment of the present disclosure.

First, the control unit 11 executes the normal reflected light measurement processing (step S101). In the normal reflected light measurement processing, the control unit 11 causes the light projecting unit 13 to emit the laser light L1 and causes the light receiving unit 14 to output a detection signal based on the reflected light L2. In addition, the control unit 11 generates the above-described histogram based on the detection signal, and detects an echo based on the histogram.

Then, the control unit 11 determines whether a saturated echo saturated for a predetermined time or more is present among the detected echoes (step S102). When the saturated echo is not present (step S102, No), the control unit 11 outputs, to the host 80, information regarding the distance based on the normal reflected light measurement processing in step S101, and repeats the processing from step S101.

When the saturated echo is present (step S102, Yes), the control unit 11 extracts the saturated echo as a target for the latent echo search processing (step S103). Then, the control unit 11 determines the SPAD invalidation section from the start time point of each of the extracted saturated echoes (step S104). The control unit 11 determines the SPAD invalidation section so that the SPAD invalidation section having the observation start time point of the saturated echo as a reference gradually decreases by the SPAD validation section retrospectively extending from the observation end time point side of the saturated echo for every one emission of the laser light L1 in the latent echo search processing. In addition, the control unit 11 controls the enable signal for the SPAD pixel 20 to turn on/off according to the determined content.

Furthermore, the control unit 11 determines whether the above-described end condition of the latent echo search processing is satisfied (step S105).

When the end condition is satisfied (step S105, Yes), the control unit 11 repeats the processing from step S101. When the end condition is not satisfied (step S105, No), the control unit 11 makes the laser light L1 to be emitted once and measures the reflected light L2 (step S106).

Then, the control unit 11 generates the above-described histogram based on the measurement result (step S107), and determines whether a rise of a latent echo has been detected from the histogram (step S108).

When the rise of the latent echo cannot be detected (step S108, No), the control unit 11 repeats the processing from step S101. In addition, when the rise of the latent echo is detected (step S108, Yes), the control unit 11 separates and records the latent echo from the saturated echo (step S109), and repeats the processing from step S104.

### 4. Modifications

By the way, the embodiment of the present disclosure described above can include several modifications.

### 4-1. Combination With Flare Removal Processing and Effect Thereof

FIG. 10 is a block diagram illustrating a configuration example of a control unit 11A according to the modification. In addition, FIG. 11 is an explanatory diagram in a case of being combined with the flare removal processing. Note that, since FIG. 10 corresponds to FIG. 8, points different from FIG. 8 will be mainly described here.

The control unit 11A according to the modification is different from the control unit 11 in FIG. 8 in further including a flare removal unit 11f. The flare removal unit 11f executes flare removal processing of removing flare in which scattered light of highly reflected light saturates the surrounding SPAD pixels 20 and is detected as a false echo. In the flare removal processing, data in a flare region including flare is removed by performing predetermined filter processing.

In a case where the flare removal processing is combined, it becomes possible for the control method according to the present embodiment to prevent true echoes that could not be observed due to flare from being removed by the flare removal processing in the existing technology.

This will be specifically described with reference to FIG. 11. As illustrated in FIG. 11, there is considered a case where different objects 90-1 and 90-2 are present in a two-dimensional space including a horizontal direction and a depth direction as “arrangement on depth”. It is assumed that the object 90-1 is a strong reflector.

Here, in the normal reflected light measurement processing, the ToF sensor according to the existing technology observes an echo e-1 from the object 90-1 with flare f spreading in a flare region R as indicated in “observation echo” in the drawing, but cannot observe an echo of the object 90-2. This is because the echo of the object 90-2 overlaps the dead time of the flare f.

Then, the ToF sensor according to the existing technology removes the flare f included in the flare region R when executing the flare removal processing as indicated in “flare removal”, but also removes data of the hidden (unrecognized) object 90-2 or the like included in the flare region R.

As a result, the ToF sensor according to the existing technology cannot detect the object 90-2 that cannot be observed due to the flare f to the end as indicated in “detection result”.

Meanwhile, in “arrangement on depth” same as in the existing technology, the ToF sensor 1 according to the present embodiment observes an echo e-1 from the object 90-1 with the flare f spreading in the flare region R as indicated in “observation echo”. At the same time, the ToF sensor 1 according to the present embodiment observes an echo e-2 of the object 90-2 separately from the flare f by the latent echo search processing for the flare f.

Then, as indicated in “flare removal”, even if the flare removal unit 11f executes the flare removal processing on the flare region R, the echo e-2 is separated and recorded (recognized), and thus is not removed from the flare region R.

As a result, as indicated in “detection result”, the ToF sensor 1 according to the present embodiment can detect a true echo of the object 90-2 that cannot be initially observed due to the flare f without removing the true echo by the flare removal processing.

### <4-2. Determination of Length of SPAD Invalidation Section and SPAD Validation Section

In addition, in the present embodiment, the fixed value of the length of the SPAD validation section and/or the fixed value of the length of the SPAD invalidation section having the observation end time point of the saturated echo as a reference, are set in advance in the LUT 12b.

Meanwhile, in the LUT 12b, the above-described fixed value may be set in advance such that the fixed value changes according to, for example, the dead time characteristic of the SPAD or the like having the observation start time point of the saturated echo as a reference.

### 4-3. Ratio Between SPAD Invalidation Section and SPAD Validation Section

In addition, in the present embodiment, as illustrated in FIG. 7, the example is described in which the ratio between the SPAD invalidation section and the SPAD validation section changes as 1:1, 1:3, and so on for every one emission of the laser light L1, but this is merely an example and the ratio is not limited thereto.

For example, the ratio between the SPAD invalidation section and the SPAD validation section may change as 3:1, 1:1, 1:3, and so on for every one emission of the laser light L1. In addition, this ratio is not limited to a case where the observation start time point to the observation end time point of the saturated echo are divided into four, and may be a case of dividing into less than four, or may be a case of dividing into five or more. Furthermore, this ratio is not necessarily a ratio of natural number: natural number.

### 4-4. Others

In addition, among the pieces of processing described in the embodiment described above, all or a part of the processing described as being performed automatically can be performed manually, or all or a part of the processing described as being performed manually can be performed automatically by a known method. Moreover, the processing procedure, specific name, and information including various data and parameters illustrated in the document described above and the drawings can be arbitrarily changed unless otherwise specified. For example, the various types of information illustrated in each drawing are not limited to the illustrated information.

In addition, each of the components in each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the embodiments of the present disclosure described above can be appropriately combined in a region in which the processing contents do not contradict each other. Furthermore, the order of each step illustrated in the sequence diagram or the flowchart of the present embodiment can be changed as appropriate.

### 5. Hardware Configuration

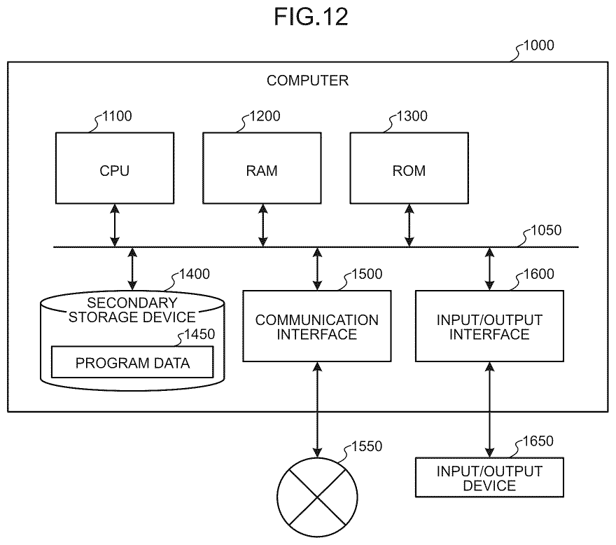

In addition, the ToF sensor 1 according to the embodiment of the present disclosure described above is implemented by a computer 1000 having a configuration as illustrated in FIG. 12, for example. FIG. 12 is a hardware configuration diagram illustrating an example of the computer 1000 that implements the functions of the ToF sensor 1. The computer 1000 includes a CPU 1100, a RAM 1200, a ROM 1300, a secondary storage device 1400, a communication interface 1500, and an input/output interface 1600. Each unit of the computer 1000 is connected by a bus 1050.

The CPU 1100 operates based on a program stored in the ROM 1300 or the secondary storage device 1400, and controls each unit. For example, the CPU 1100 develops the program stored in the ROM 1300 or the secondary storage device 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The secondary storage device 1400 is a computer-readable recording medium that non-transiently records a program executed by the CPU 1100, data used by the program, and the like. Specifically, the secondary storage device 1400 is a recording medium that records the program according to the present embodiment or the program according to the modification.

The communication interface 1500 is an interface for the computer 1000 to connect to an external network 1550. For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (a medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the ToF sensor 1, the CPU 1100 of the computer 1000 implements the function of the control unit 11 by executing a program loaded on the RAM 1200. In addition, the secondary storage device 1400 stores a program according to the present disclosure, a program according to the modification, and data in the storage unit 12. Note that the CPU 1100 reads program data 1450 from the secondary storage device 1400 and executes the program data, but as another example, these programs may be acquired from other devices via the external network 1550.

### 6. Application Example

A technology according to the present disclosure is applicable to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a boat, a robot, a construction machine, an agricultural machine (tractor), and the like.

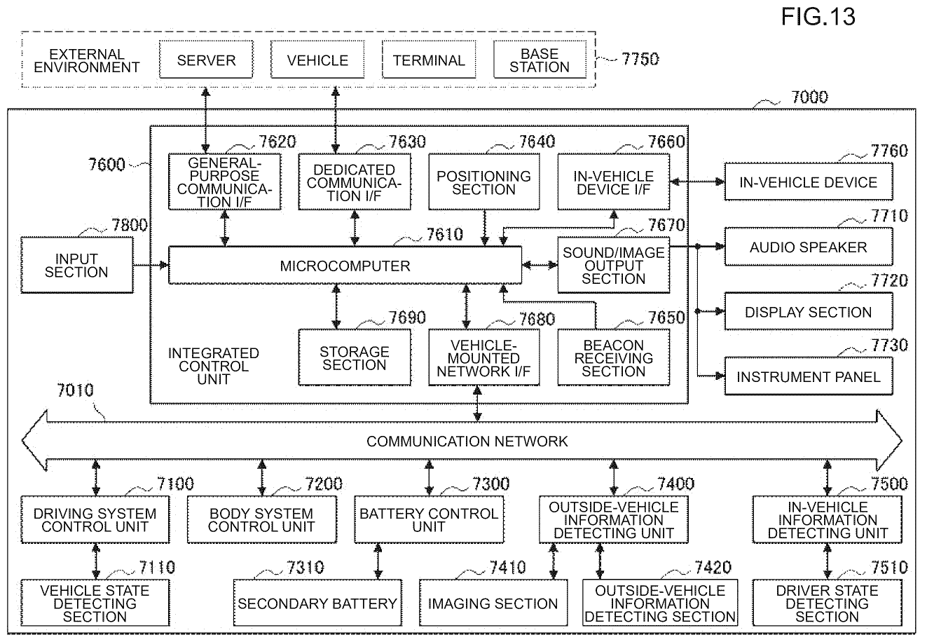

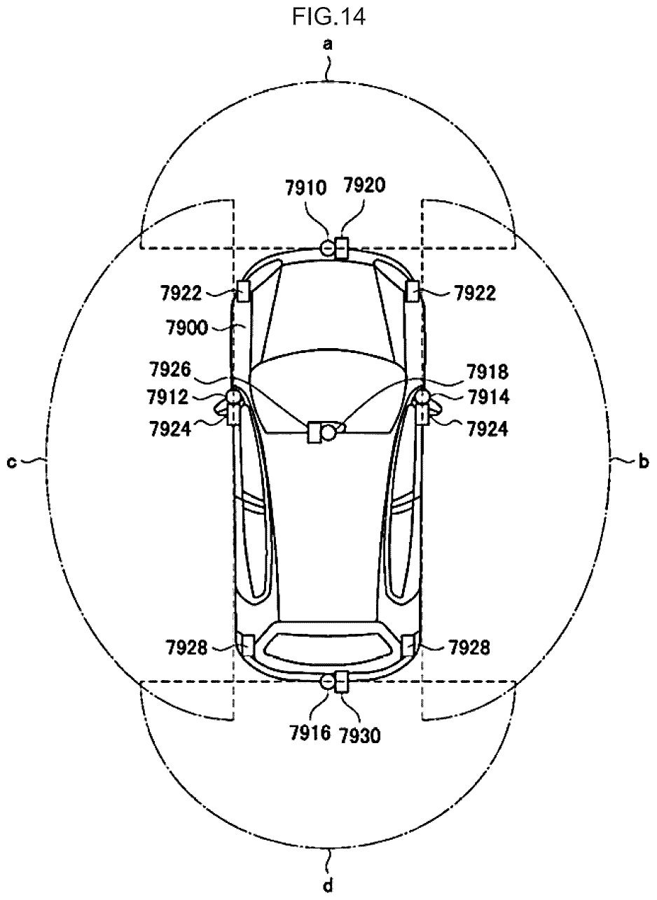

FIG. 13 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 13, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as CAN, LIN, LAN, FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 13 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

FIG. 14 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 14 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 13, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a ROM that stores various kinds of programs executed by the microcomputer and a RAM that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark) ), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 13, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 13 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a program for implementing each function of the control section 11 according to the present embodiment described with reference to FIG. 1 can be mounted on any control unit or the like. Furthermore, it is also possible to provide a computer-readable recording medium storing such a program. The recording medium is, for example, a magnetic disk, an optical disk, a magneto-optical disk, a flash memory, or the like. The recording medium is also one mode of the present disclosure. In addition, the program described above may be distributed via, for example, a network without using the recording medium.

In the vehicle control system 7000 described above, the distance measuring device (ToF sensor) according to the above-described embodiment or modification can be applied to the outside-vehicle information detecting section 7420 and/or the driver state detecting section 7510 of the application example illustrated in FIG. 13. Thus, it is possible to measure the distance with higher accuracy, and thus it is possible to achieve safer driving support and automated driving.

### 7. Conclusion

As described above, according to the embodiment of the present disclosure, the control unit 11 (corresponding to an example of a “control device”) is a control device that detects an echo with respect to the pulsed laser light L1 (corresponding to an example of “emission light”) based on the physical quantity of photons incident on each of the plurality of SPAD pixels 20 (corresponding to an example of “pixels”) arranged. The control unit 11 includes the invalidation section determination unit 11d (corresponding to an example of a “determination unit”) and the SPAD control unit 11e (corresponding to an example of a “pixel control unit”). In a case where the saturated echo in which the echo is saturated for a predetermined time or more is detected, the invalidation section determination unit 11d determines the SPAD invalidation section (corresponding to an example of an “invalidation section”) so that the start time point of the SPAD invalidation section invalidating the SPAD pixel 20 that has detected the saturated echo is set as the start time point of the saturated echo and the SPAD invalidation section gradually decreases every time the laser light L1 is emitted. The SPAD control unit 11e invalidates the SPAD pixel 20 according to the determined SPAD invalidation section and makes the laser light L1 to be emitted. This makes it possible to observe an echo that cannot be observed during the dead time.

Although the embodiment of the present disclosure has been described above, the technical scope of the present disclosure is not limited to the above-described embodiment as it is, and various modifications can be made without departing from the gist of the present disclosure. In addition, components of different embodiment and modifications may be appropriately combined.

Furthermore, the effects of the embodiment described in the present specification are merely examples and are not limited, and other effects may be provided.

Note that the present technology can also have the following configurations.
(1)
A control device that detects an echo with respect to pulsed emission light based on a physical quantity of photons incident on each of a plurality of pixels arranged, the control device comprising:
a determination unit that, in a case where a saturated echo in which the echo is saturated for a predetermined time or more is detected, determines an invalidation section such that a start time point of the invalidation section invalidating the pixel that has detected the saturated echo is set as a start time point of the saturated echo and the invalidation section gradually decreases every time the emission light is emitted; and a pixel control unit that invalidates the pixel according to the determined invalidation section and makes the emission light to be emitted.
(2)
The control device according to (1), wherein the determination unit determines the invalidation section such that the invalidation section and a validation section with respect to the invalidation section are provided at an arbitrary ratio between the start time point and an end time point of the saturated echo.
(3)
The control device according to (2), wherein
the determination unit determines the invalidation section such that a period between the start time point and the end time point is divided into a predetermined interval and the invalidation section gradually decreases according to the interval every time the emission light is emitted.
(4)
The control device according to (3), wherein
the period between the start time point and the end time point is divided into four portions, and
the determination unit determines the invalidation section such that the invalidation section gradually decreases according to the interval of the four portions every time the emission light is emitted.
(5)
The control device according to (2), (3), or (4), wherein
the determination unit determines the invalidation section based on a lookup table in which at least one of a fixed value of the invalidation section or a fixed value of the validation section having the end time point as a reference, is set in advance.

(6)
The control device according to (2), (3), or (4), wherein
the determination unit determines the invalidation section based on a lookup table in which at least one of a fixed value of the invalidation section or a fixed value of the validation section having the start time point as a reference, is set in advance.
(7)
The control device according to (6), wherein
the determination unit determines the invalidation section based on the lookup table in which the fixed value is set in advance according to a dead time characteristic of the pixel.

(8)
The control device according to any one of (1) to (7), wherein
in a case where it is determined that a predetermined end condition is satisfied, latent echo search processing by the determination unit and the pixel control unit when the saturated echo is detected is ended.
(9)
The control device according to (8), wherein the end condition includes
a case where a number of executions of the latent echo search processing exceeds a first specified value or a case where a length of the invalidation section becomes equal to or less than a second specified value.
(10)
The control device according to any one of (1) to (9), further comprising
a flare removal unit that removes flare caused by scattered light of highly reflected light by predetermined filter processing.
(11)
A distance measuring device comprising:
a light projecting unit that emits pulsed emission light;
a light receiving unit in which a plurality of pixels each detecting incidence of photons is arranged;
a detection unit that detects an echo with respect to the emission light based on a physical quantity of the photons output from each of the pixels;
a determination unit that, in a case where a saturated echo in which the echo is saturated for a predetermined time or more is detected by the detection unit, determines an invalidation section such that a start time point of the invalidation section invalidating the pixel that has detected the saturated echo is set as a start time point of the saturated echo and the invalidation section gradually decreases every time the emission light is emitted; and
a pixel control unit that invalidates the pixel according to the determined invalidation section and causes the light projecting unit to emit the emission light.
(12)
A control method executed by a control device that detects an echo with respect to pulsed emission light based on a physical quantity of photons incident on each of a plurality of pixels arranged, the control method comprising:
in a case where a saturated echo in which the echo is saturated for a predetermined time or more is detected, determining an invalidation section such that a start time point of the invalidation section invalidating the pixel that has detected the saturated echo is set as a start time point of the saturated echo and the invalidation section gradually decreases every time the emission light is emitted; and
invalidating the pixel according to the determined invalidation section and making the emission light to be emitted.
(13)
A computer-readable recording medium on which a program is recorded, the program causing a computer to execute processing including:
detecting an echo with respect to pulsed emission light based on a physical quantity of photons incident on each of a plurality of pixels arranged;
in a case where a saturated echo in which the echo is saturated for a predetermined time or more is detected, determining an invalidation section such that a start time point of the invalidation section invalidating the pixel that has detected the saturated echo is set as a start time point of the saturated echo and the invalidation section gradually decreases every time the emission light is emitted; and
invalidating the pixel according to the determined invalidation section and making the emission light to be emitted.

### REFERENCE SIGNS LIST

1 ToF SENSOR
11, 11A CONTROL UNIT
11a LIGHT PROJECTION CONTROL UNIT
11b HISTOGRAM GENERATION UNIT
11c ECHO DETECTION UNIT
11d INVALIDATION SECTION DETERMINATION UNIT
11e SPAD CONTROL UNIT
11f FLARE REMOVAL UNIT
12 STORAGE UNIT
12a CUMULATIVE MEMORY
12b LUT
13 LIGHT PROJECTING UNIT
14 LIGHT RECEIVING UNIT
19 EXTERNAL I/F
20 SPAD PIXEL
31 SOURCE
32 COLLIMATOR LENS
33 HALF MIRROR
34 DRIVE UNIT
35 GALVANO MIRROR
36 LIGHT RECEIVING SENSOR
37 SPAD ARRAY
38 LIGHT RECEIVING LENS
43 TIMING CONTROL CIRCUIT
44 DRIVE CIRCUIT
45 OUTPUT CIRCUIT
80 HOST
90 OBJECT

1. A control device that detects an echo with respect to pulsed emission light based on a physical quantity of photons incident on each of a plurality of pixels arranged, the control device comprising:
a determination unit that, in a case where a saturated echo in which the echo is saturated for a predetermined time or more is detected, determines an invalidation section such that a start time point of the invalidation section invalidating the pixel that has detected the saturated echo is set as a start time point of the saturated echo and the invalidation section gradually decreases every time the emission light is emitted; and
a pixel control unit that invalidates the pixel according to the determined invalidation section and makes the emission light to be emitted.

2. The control device according to claim 1, wherein the determination unit determines the invalidation section such that the invalidation section and a validation section with respect to the invalidation section are provided at an arbitrary ratio between the start time point and an end time point of the saturated echo.

3. The control device according to claim 2, wherein the determination unit determines the invalidation section such that a period between the start time point and the end time point is divided into a predetermined interval and the invalidation section gradually decreases according to the interval every time the emission light is emitted.

4. The control device according to claim 3, wherein the period between the start time point and the end time point is divided into four portions, and
the determination unit determines the invalidation section such that the invalidation section gradually decreases according to the interval of the four portions every time the emission light is emitted.

5. The control device according to claim 2, wherein
the determination unit determines the invalidation section based on a lookup table in which at least one of a fixed value of the invalidation section or a fixed value of the validation section having the end time point as a reference, is set in advance.

6. The control device according to claim 2, wherein
the determination unit determines the invalidation section based on a lookup table in which at least one of a fixed value of the invalidation section or a fixed value of the validation section having the start time point as a reference, is set in advance.

7. The control device according to claim 6, wherein
the determination unit determines the invalidation section based on the lookup table in which the fixed value is set in advance according to a dead time characteristic of the pixel.

8. The control device according to claim 1, wherein
in a case where it is determined that a predetermined end condition is satisfied, latent echo search processing by the determination unit and the pixel control unit when the saturated echo is detected is ended.

9. The control device according to claim 8, wherein the end condition includes
a case where a number of executions of the latent echo search processing exceeds a first specified value or a case where a length of the invalidation section becomes equal to or less than a second specified value.

10. The control device according to claim 1, further comprising
a flare removal unit that removes flare caused by scattered light of highly reflected light by predetermined filter processing.

11. A distance measuring device comprising:
a light projecting unit that emits pulsed emission light;
a light receiving unit in which a plurality of pixels each detecting incidence of photons is arranged;
a detection unit that detects an echo with respect to the emission light based on a physical quantity of the photons output from each of the pixels;
a determination unit that, in a case where a saturated echo in which the echo is saturated for a predetermined time or more is detected by the detection unit, determines an invalidation section such that a start time point of the invalidation section invalidating the pixel that has detected the saturated echo is set as a start time point of the saturated echo and the invalidation section gradually decreases every time the emission light is emitted; and
a pixel control unit that invalidates the pixel according to the determined invalidation section and causes the light projecting unit to emit the emission light.

12. A control method executed by a control device that detects an echo with respect to pulsed emission light based on a physical quantity of photons incident on each of a plurality of pixels arranged, the control method comprising:
in a case where a saturated echo in which the echo is saturated for a predetermined time or more is detected, determining an invalidation section such that a start time point of the invalidation section invalidating the pixel that has detected the saturated echo is set as a start time point of the saturated echo and the invalidation section gradually decreases every time the emission light is emitted; and
invalidating the pixel according to the determined invalidation section and making the emission light to be emitted.
